(19) United States
(12) Patent Application Publication
(10) Pub. No.: US 2020/0272995 A1
(43) Pub. Date: Aug. 27, 2020

(54) PORTABLE VERIFIED WORK HISTORY

(71) Applicant: Nathanael K. Duval-Igarta, Bonney Lake, WA (US)

(72) Inventor: Nathanael K. Duval-Igarta, Bonney Lake, WA (US)

(21) Appl. No.: 16/287,924

(22) Filed: Feb. 27, 2019

(51) Int. Cl. G06Q 10/10; G06Q 10/06; G06F 16/9535

(52) U.S. Cl. CPC G06Q 10/1053; G06F 16/9535; G06Q 10/063114; G06Q 10/06398

(57) ABSTRACT

Systems and methods are described for generating a verified work history that is transferable between organizations is described. The method may include receiving a digital proof of work from a first user, transmitting the digital proof of work to users within a first organization, receiving a verification of the proof of work (i.e., feedback from the users), generating an automated work record for the first user based at least in part on the verification of the proof of work, wherein at least a portion of the automated work record is associated with the first organization, and displaying the automated work record to a second user in a second organization.

### BACKGROUND

The following relates generally to generating a verified work history, and more specifically to generating a verified work history that is transferable between organizations.

Many workers maintain a record of their accomplishments in the form of a resume. The resume may be provided to prospective employers to provide information about the workers' skills and accomplishments. However, in some cases it may be difficult to obtain validation of accomplishments on a resume. A job candidate may provide references but contacting the appropriate references may be difficult and time consuming.

Furthermore, relying on references to validate a work history may put workers at a disadvantage. For example, supervisors and co-workers may withhold positive references when a worker chooses to leave an employer, even if the accomplishments are valid. This may result in a lack of motivation for employees of a firm to maximize their accomplishments, which may negatively impact both the firm and the employees.

### SUMMARY

A method for generating a verified work history that is transferable between organizations is described. The method may include receiving a digital proof of work from a first user, transmitting the digital proof of work to a plurality of users within a first organization, receiving a verification of the proof of work comprising feedback from the plurality of users, generating an automated work record for the first user based at least in part on the verification of the proof of work, wherein at least a portion of the automated work record is associated with the first organization, and transmitting the automated work record to a second user.

An apparatus for generating a verified work history is described. The apparatus may include a processor, memory in electronic communication with the processor, and instructions stored in the memory. The instructions may be operable to cause the processor to receive a digital proof of work from a first user, transmit the digital proof of work to a plurality of users within a first organization, receive a verification of the proof of work comprising feedback from the plurality of users, generate an automated work record for the first user based at least in part on the verification of the proof of work, wherein at least a portion of the automated work record is associated with the first organization, and display the automated work record to a second user.

A non-transitory computer readable medium storing code for generating a verified work history is described. In some examples, the code comprises instructions executable by a processor to: receive a digital proof of work from a first user, transmit the digital proof of work to a plurality of users within a first organization, receive a verification of the proof of work comprising feedback from the plurality of users, generate an automated work record for the first user based at least in part on the verification of the proof of work, wherein at least a portion of the automated work record is associated with the first organization, and display the automated work record to a second user.

Some examples of the method, apparatus, and non-transitory computer readable medium described above may further include increasing a resume credit score based at least in part on verification, wherein the automated work record comprises the resume credit score.

Some examples of the method, apparatus, and non-transitory computer readable medium described above may further include receiving a second digital proof of work from the first user. Some examples of the method, apparatus, and non-transitory computer readable medium described above may further include transmitting the second digital proof of work to a second plurality of users within the first organization. Some examples of the method, apparatus, and non-transitory computer readable medium described above may further include receiving an indication that the second digital proof of work is invalid. Some examples of the method, apparatus, and non-transitory computer readable medium described above may further include decreasing the resume credit score based at least in part on the indication that the second digital proof of work is invalid.

Some examples of the method, apparatus, and non-transitory computer readable medium described above may further include receiving a record of a work history, wherein the record of the work history covers a plurality of work accomplishments, a work time period, or both. Some examples of the method, apparatus, and non-transitory computer readable medium described above may further include transmitting the record of the work history to a second plurality of users within the first organization. Some examples of the method, apparatus, and non-transitory computer readable medium described above may further include receiving a verification of the record of the work history based on feedback from the second plurality of users. Some examples of the method, apparatus, and non-transitory computer readable medium described above may further include updating the automated work record for the first user based at least in part on the verification of the record of the work history.

In some examples of the method, apparatus, and non-transitory computer readable medium described above, the digital proof of work comprises a digital image of a work product. Some examples of the method, apparatus, and non-transitory computer readable medium described above may further include preventing the first user from modifying a verified portion of the automated work record.

Some examples of the method, apparatus, and non-transitory computer readable medium described above may further include receiving a request from the second user to view the automated work record. Some examples of the method, apparatus, and non-transitory computer readable medium described above may further include verifying identifying information of the second user, wherein the identifying information of the second user comprises an association with a second organization different from the first organization, wherein the automated work record is displayed based at least in part on the verification of the identifying information.

Some examples of the method, apparatus, and non-transitory computer readable medium described above may further include receiving a request from the first user to provide access to the automated work record to the second user, wherein the automated work record is displayed based at least in part on the request. Some examples of the method, apparatus, and non-transitory computer readable medium described above may further include receiving an indication that the first user has purchased access to the automated work record. Some examples of the method, apparatus, and non-transitory computer readable medium described above may further include determining that the first user is authorized to provide access to the automated work record based on the indication, wherein the automated work record is displayed based at least in part on the determination.

Some examples of the method, apparatus, and non-transitory computer readable medium described above may further include receiving an indication that the second user has purchased access to the automated work record. Some examples of the method, apparatus, and non-transitory computer readable medium described above may further include determining that the second user is authorized to provide access to the automated work record based on the indication, wherein the automated work record is displayed based at least in part on the determination. Some examples of the method, apparatus, and non-transitory computer readable medium described above may further include receiving a request to create a work category from a representative of the first organization. Some examples of the method, apparatus, and non-transitory computer readable medium described above may further include generating the work category based on the request, wherein the digital proof of work corresponds to the work category.

Some examples of the method, apparatus, and non-transitory computer readable medium described above may further include identifying a subdivision of the first organization comprising the first user, wherein the digital proof of work is transmitted to the plurality of users based at least in part on the subdivision. In some examples of the method, apparatus, and non-transitory computer readable medium described above, the subdivision is associated with a geographic region. In some examples of the method, apparatus, and non-transitory computer readable medium described above, the automated work history comprises work achievements, challenge completions, an engagement rating, a peer comparison, an estimate of monetary value, or any combination thereof.

Some examples of the method, apparatus, and non-transitory computer readable medium described above may further include transmitting a subsequent digital proof of work for a third user in the first organization to the first user. Some examples of the method, apparatus, and non-transitory computer readable medium described above may further include receiving feedback on the subsequent digital proof of work from the first user. Some examples of the method, apparatus, and non-transitory computer readable medium described above may further include updating the automated work record of the first user based on the feedback from the first user for the subsequent digital proof of work. Some examples of the method, apparatus, and non-transitory computer readable medium described above may further include determining whether the feedback received from the first user is consistent with other feedback received for the subsequent digital proof of work, wherein the automated work record of the first user is updated based on whether the feedback received from the first user is consistent.

Some examples of the method, apparatus, and non-transitory computer readable medium described above may further include querying a database of the first organization for information corresponding to a transaction associated with the digital proof of work. Some examples of the method, apparatus, and non-transitory computer readable medium described above may further include receiving an indication from the database indicating whether the digital the transaction is valid, wherein the automated work history is generated based at least in part on the indication.

### BRIEF DESCRIPTION OF THE DRAWINGS

FIG. 1 shows an example of a system for generating a work history in accordance with aspects of the present disclosure.

FIG. 2 shows an example of an apparatus for generating a work history in accordance with aspects of the present disclosure.

FIG. 3 shows an example of a process for verifying a work history in accordance with aspects of the present disclosure.

FIGS. 4 through 6 show examples of a process for generating a verified work history that is transferable between organizations in accordance with aspects of the present disclosure.

### DETAILED DESCRIPTION

Traditionally, participants in the labor force have maintained a record of their accomplishments in the form of a resume. The resume may be provided to prospective employers to provide information about the workers' skills and accomplishments. However, in some cases it may be difficult to obtain validation of accomplishments on a resume. For example, supervisors and co-workers may withhold positive references when a worker chooses to leave an employer, even if the accomplishments are valid. This may result in a lack of motivation for employees of a firm to maximize their accomplishments, which may negatively impact both the firm and the employees.

Thus, it may be in the interest of both firms and employees to provide employees with a method of verifying accomplishments during the course of their employment. Therefore the present disclosure describes systems and methods for verifying accomplishments using a peer-to-peer verification, and maintaining the record in a way that is transferable across organizations. That is, if an employee transitions form one job to another, a record of their accomplishments is maintained in a way that provides authoritative verification for users outside the organizational unit that provided verification for the accomplishments. Thus, a “static”, transferable resume may be generated, at least a portion of which is not directly changeable by the user.

The verification may be performed when an organization selects a type of work to be accomplished, (and selects parameters for verifying accomplishment). A user may receive a notification of the type of work, and may upload verification when the work is accomplished. For example, a user may provide photographs as proof that they have accomplished specific categories of work, achievements, status, challenges, or job requirements that a company has set. These proof of work (e.g., photographic evidence) may be verified using a peer-to-peer verification system. This may enable work to be verified in an immutable way, so that the resulting work record may be relied upon by subsequent employers.

Aspects of the present disclosure may also relate to a resume “Credit Score.” The resume score may be calculated in a manner similar to a financial credit score (i.e., based on a scale where 500 is acceptable, 650 is good, and 850 is perfect). However, the resume score may be calculated on the basis of accomplishments and status within the described systems an applications. The resume score may be used to translate accomplishments from one career context to another. Additionally or alternatively, quantitative measures may be maintained and collected such as measures comparing the accomplishments of different employees within an organizational unit, or measures of the economic value generated by an employee.

A number of factors may impact the resume score, and other quantitative factors within an automated work history. These factors may include daily achievements, challenges completed, engagement through validations and with their peers within the business, login in frequency, activity, and the accomplishments of other similarly situated workers.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

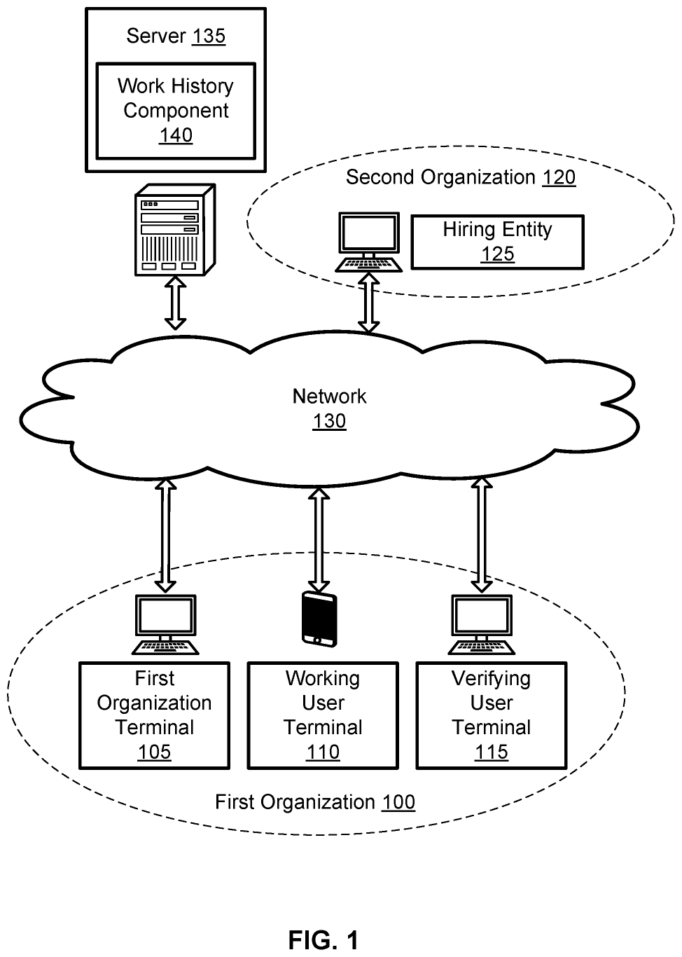

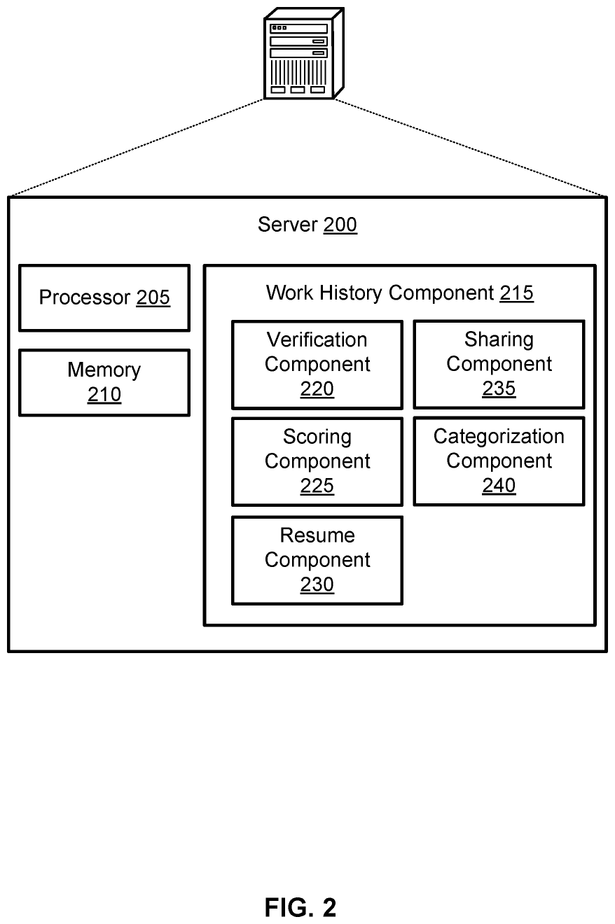

FIG. 1 shows an example of a system for generating a work history in accordance with aspects of the present disclosure. The example shown includes first organization 100, second organization 120, network 130, and server 135. First organization 100 may include first organization terminal 105, working user terminal 110, and verifying user terminal 115. Second organization 120 may include hiring entity 125. Server 135 may be an example of, or include aspects of, the corresponding element or elements described with reference to FIG. 2. Server 135 may include work history component 140.

A representative of the first organization 100 may generate one or more work categories and subcategories using first organization terminal 105. The first organization terminal 105 (i.e., via an application capable of performing methods described herein) may communicate these work categories to the server 135 (via network 130), which may then distribute the categories of work to other members of first organization 100 (e.g., a working user via working user terminal 110, and one or more verifying user via verifying user terminal(s) 115). In some cases, the verifying users are peers of the working user. In other cases, the verifying user(s) may be supervisors or superiors of the working user.

The working user may then accomplish a task related to a work category set by the first organization 100, and may upload a proof of work, such as photographic evidence, a verification code, or other proof of work. The verifying users may then provide feedback related to whether the proof of work is valid or sufficient. A work history of the working user may then be updated based on the feedback. In some cases, if the proof of work is deemed insufficient, a notification may be provided to the working user to provide more proof of work.

In some cases, it may then be appropriate for a user (e.g., a hiring entity 125) within a second organization 120 to verify the credentials of the working user. After obtaining access to the work record of the working user, the hiring entity 125 may then receive an automated resume or work history that has been previously verified by members of the first organization 100. In some cases, the first organization 100 and the second organization 120 may be subunits of a same company. In other examples, they may be different companies.

In some cases, the terminals that interact with the server 135 may do so via a web browser or via a native application. The terminals may be computing devices such as personal computers or mobile computing devices (e.g., a mobile phone or tablet). In some examples, the working user terminal may include an application capable of taking photographs, (i.e., a mobile phone with a camera) and the application which interacts with the cloud-based server 135 may be capable of obtaining photographs from the camera as proof of work.

FIG. 2 shows an example of an apparatus (i.e., server 200) for generating a work history in accordance with aspects of the present disclosure. Although the apparatus is described as server 200, it may be any computing device capable of connecting to a network (i.e., the internet) such as a personal computer, laptop computer, mainframe computer, mobile device, or any other suitable processing apparatus an example of, or include aspects of, the corresponding element or elements described with reference to FIG. 1. Server 200 may include processor 205, memory 210, and work history component 215. In some examples, server 200 may be a “serverless” application running on a cloud computing device.

A processor 205 may include an intelligent hardware device, (e.g., a general-purpose processing component, a DSP, a CPU, a microcontroller, an ASIC, an FPGA, a programmable logic device, a discrete gate or transistor logic component, a discrete hardware component, or any combination thereof). In some cases, the processor 205 may be configured to operate a memory array using a memory controller. In other cases, a memory controller may be integrated into processor. The processor 205 may be configured to execute computer-readable instructions stored in a memory to perform various functions.

Memory 210 may include RAM, ROM, or a hard disk. The memory 210 may be solid state or a hard disk drive, and may include store computer-readable, computer-executable software including instructions that, when executed, cause a processor 205 to perform various functions described herein. In some cases, the memory 210 may contain, among other things, a BIOS which may control basic hardware or software operation such as the interaction with peripheral components or devices. In some cases, a memory controller may operate memory cells as described herein. In some cases, memory controller may include a row decoder, column decoder, or both. In some cases, memory cells within a memory may store information in the form of a logical state.

Work history component 215 may be an example of, or include aspects of, the corresponding element or elements described with reference to FIG. 1. In some examples, work history component 215 may be a software component located within memory 210. In other examples work history component 215 may be a special-purpose hardware or firmware component. Work history component 215 may include verification component 220, scoring component 225, resume component 230, sharing component 235, and categorization component 240.

Verification component 220 may receive a digital proof of work from a first user. Verification component 220 may also transmit the digital proof of work to a plurality of users within a first organization. Verification component 220 may also receive a verification of the proof of work comprising feedback from the plurality of users. Verification component 220 may also transmit the second digital proof of work to a second plurality of users within the first organization. Verification component 220 may also receive an indication that the second digital proof of work is invalid.

Verification component 220 may also receive a record of a work history, wherein the record of the work history covers a plurality of work accomplishments, a work time period, or both. Verification component 220 may also transmit the record of the work history to a second plurality of users within the first organization. Verification component 220 may also receive a verification of the record of the work history based on feedback from the second plurality of users. In some examples, the digital proof of work comprises a digital image of a work product.

Verification component 220 may also identify a subdivision of the first organization comprising the first user, wherein the digital proof of work is transmitted to the plurality of users based at least in part on the subdivision. In some examples, the subdivision is associated with a geographic region. Verification component 220 may also transmit a subsequent digital proof of work for a third user in the first organization to the first user. Verification component 220 may also receive feedback on the subsequent digital proof of work from the first user. Verification component 220 may also determine whether the feedback received from the first user is consistent with other feedback received for the subsequent digital proof of work, wherein the automated work record of the first user is updated based on whether the feedback received from the first user is consistent.

Verification component 220 may also query a database of the first organization (not shown) for information corresponding to a transaction associated with the digital proof of work. Verification component 220 may also receive an indication from the database indicating whether the digital the transaction is valid, wherein the automated work history is generated based at least in part on the indication.

Scoring component 225 may increase a resume credit score based at least in part on verification, wherein the automated work record comprises the resume credit score. Scoring component 225 may also decrease the resume credit score based at least in part on the indication that the second digital proof of work is invalid.

Resume component 230 may generate an automated work record for the first user based at least in part on the verification of the proof of work, wherein at least a portion of the automated work record is associated with the first organization. Resume component 230 may also update the automated work record for the first user based at least in part on the verification of the record of the work history. Resume component 230 may also prevent the first user from modifying a verified portion of the automated work record. In some examples, the automated work history comprises work achievements, challenge completions, an engagement rating, a peer comparison, an estimate of monetary value, or any combination thereof. Resume component 230 may also update the automated work record of the first user based on the feedback from the first user for the subsequent digital proof of work.

Sharing component 235 may display the automated work record to a second user. Sharing component 235 may also receive a request from the second user to view the automated work record. Sharing component 235 may also verify identifying information of the second user, wherein the identifying information of the second user comprises an association with a second organization different from the first organization, wherein the automated work record is displayed based at least in part on the verification of the identifying information. Sharing component 235 may also receive a request from the first user to provide access to the automated work record to the second user, wherein the automated work record is displayed based at least in part on the request.

Sharing component 235 may also receive an indication that the first user has purchased access to the automated work record. Sharing component 235 may also determine that the first user is authorized to provide access to the automated work record based on the indication, wherein the automated work record is displayed based at least in part on the determination. Sharing component 235 may also receive an indication that the second user has purchased access to the automated work record. Sharing component 235 may also determine that the second user is authorized to provide access to the automated work record based on the indication, wherein the automated work record is displayed based at least in part on the determination.

Categorization component 240 may receive a request to create a work category from a representative of the first organization. Categorization component 240 may also generate the work category based on the request, wherein the digital proof of work corresponds to the work category.

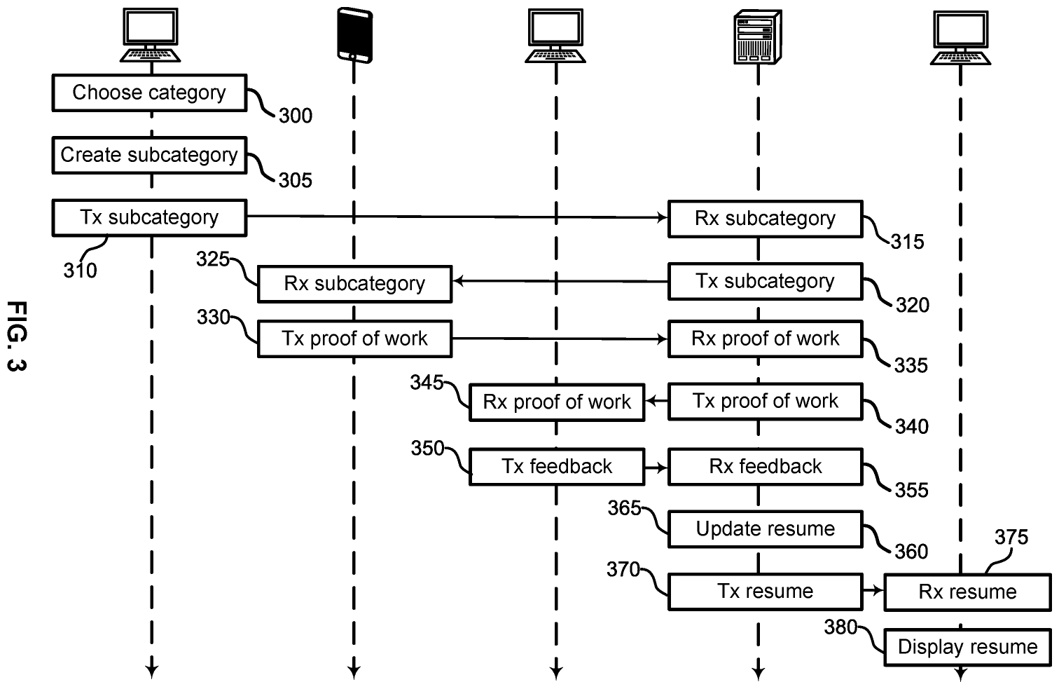

FIG. 3 shows an example of a process for verifying a work history in accordance with aspects of the present disclosure. In some examples, these operations may be performed by a system of computing devices that include a processor executing a set of codes to control functional elements of the devices. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 300, a representative of an organization (e.g., a first company) may choose a main category of work. In some cases, the operations of this step may refer to, or be performed by, a first organization terminal as described with reference to FIG. 1. In some cases, the operations of this step may refer to, or be performed by, a categorization component as described with reference to FIG. 2.

At step 305, the organization representative may create a subcategory or work (i.e., a specific job type or accomplishment within the main category). In some cases, the operations of this step may refer to, or be performed by, a first organization terminal as described with reference to FIG. 1. In some cases, the operations of this step may refer to, or be performed by, a categorization component as described with reference to FIG. 2.

At step 310, the organization representative may transmit the subcategory to a server. In some cases, the operations of this step may refer to, or be performed by, a first organization terminal as described with reference to FIG. 1.

At step 315, the server may receive the subcategory from the first company. In some cases, the operations of this step may refer to, or be performed by, a verification component as described with reference to FIG. 2.

At step 320, the server may transmit the subcategory to a subgroup of the first company (i.e., including a working user within a peer subgroup). In some cases, the operations of this step may refer to, or be performed by, a verification component as described with reference to FIG. 2.

At step 325, the working user may receive the subcategory from the server. In some cases, the operations of this step may refer to, or be performed by, a working user terminal as described with reference to FIG. 1.

At step 330, the working user may transmit a proof of work to the server. For example, the working user may accomplish the task or job indicated by the subcategory, and then obtain photographic evidence that the job is complete. In some cases, the operations of this step may refer to, or be performed by, a working user terminal as described with reference to FIG. 1.

At step 335, the server may receive the proof of work from the working user. In some cases, the operations of this step may refer to, or be performed by, a verification component as described with reference to FIG. 2.

At step 340, the server may transmit the proof of work to other members of the subgroup (i.e., transmit the proof of work to peers of the working user for validation). In some cases, the operations of this step may refer to, or be performed by, a verification component as described with reference to FIG. 2.

At step 345, the peers may receive the proof of work from the server. In some cases, the operations of this step may refer to, or be performed by, a verifying user terminal as described with reference to FIG. 1.

At step 350, the peers may transmit feedback to the server. In some cases, the operations of this step may refer to, or be performed by, a verifying user terminal as described with reference to FIG. 1.

At step 355, the server may receive the feedback from the subgroup. In some cases, the operations of this step may refer to, or be performed by, a verification component as described with reference to FIG. 2.

At step 360, the server may generate an automated work history (i.e., a resume) or update the resume based on the feedback. In some cases, the operations of this step may refer to, or be performed by, a resume component as described with reference to FIG. 2.

At step 365, the server may transmit the resume to a hiring entity or another user within a second company (or within a second organization subunit of the first company). In some cases, the operations of this step may refer to, or be performed by, a sharing component as described with reference to FIG. 2. In some cases, the server may perform an authorization of the hiring entity prior to transmitting the resume. For example, the server may verify that the working user has provided authorization for the second company or organization to view the resume, and that the hiring entity is an authorized entity within the second company.

At step 370, the system may receive the resume from the server. In some cases, the operations of this step may refer to, or be performed by, a second organization terminal as described with reference to FIG. 1.

At step 375, the system may display the resume to the hiring entity.

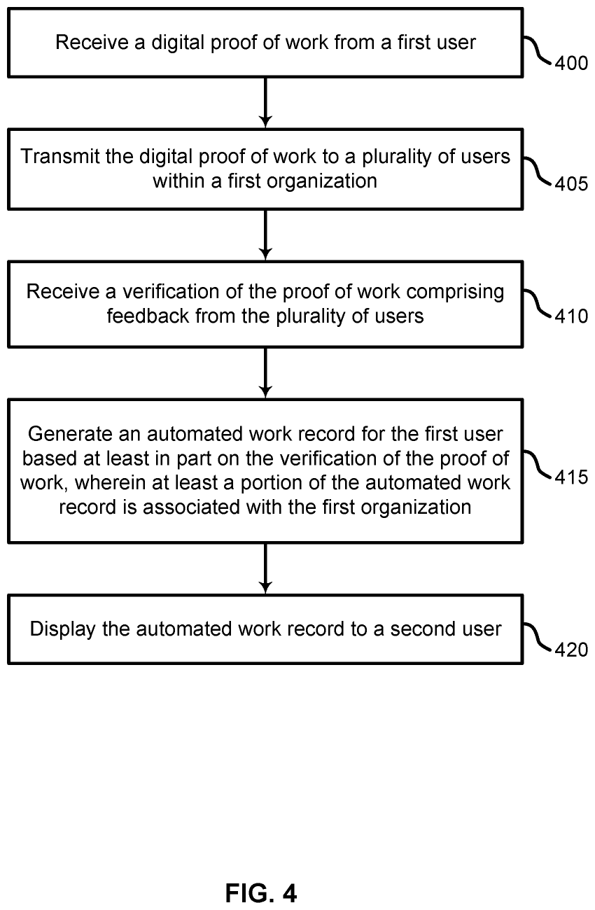

FIG. 4 shows an example of a process for generating a verified work history that is transferable between organizations in accordance with aspects of the present disclosure. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 400, the system may receive a digital proof of work from a first user (i.e., a working user). For example, the system may receive photographic evidence corresponding to a job description set by a first organization. In some cases, the operations of this step may refer to, or be performed by, a verification component as described with reference to FIG. 2.

At step 405, the system may transmit the digital proof of work to a plurality of users within a first organization (along with an indication of the job the proof of work is meant to verify). In one example, the system may retain an organization list or structure representing groups and subgroups of the first organization (i.e., based on hierarchy, job type, geographic location, etc.). The system may also include logic for identifying the relevant plurality of users within the first organization that can validate the work (which may also be based on hierarchy, job type, geographic location, etc.). In some cases, the operations of this step may refer to, or be performed by, a verification component as described with reference to FIG. 2.

At step 410, the system may receive a verification of the proof of work comprising feedback from the plurality of users. For example, the peer users may receive the proof of work and be provided with options such as “valid”, “invalid” and “need more information.” Their selection may then be recorded and sent back to a server. The feedback may then be combined and the system may determine based on the feedback whether to validate the proof of work. In some cases, different peers may be afforded different validation weight based on their position or work history. In some cases, a threshold number of users must validate a proof of work before it is recorded. In some examples, the working user may be prompted to provide additional information, in which case the validation process may be repeated until it can be either verified or determined to be invalid. In some cases, the operations of this step may refer to, or be performed by, a verification component as described with reference to FIG. 2.

At step 415, the system may generate an automated work record (i.e., a resume) for the first user based at least in part on the verification of the proof of work, wherein at least a portion of the automated work record is associated with the first organization. In some cases, certain demographic or identifying information on the resume may be editable by the first user, but the system may prevent the first user from modifying verified components of the work history (i.e., to ensure reliability of the information). In some cases, In some cases, the operations of this step may refer to, or be performed by, a resume component as described with reference to FIG. 2.

At step 420, the system may transmit and/or display the automated work record to a second user (e.g., in a second organization or in a different organizational unit of the first organization). In some cases, the system may perform an authorization procedure prior to providing access to the second user. In some cases, the operations of this step may refer to, or be performed by, a sharing component as described with reference to FIG. 2.

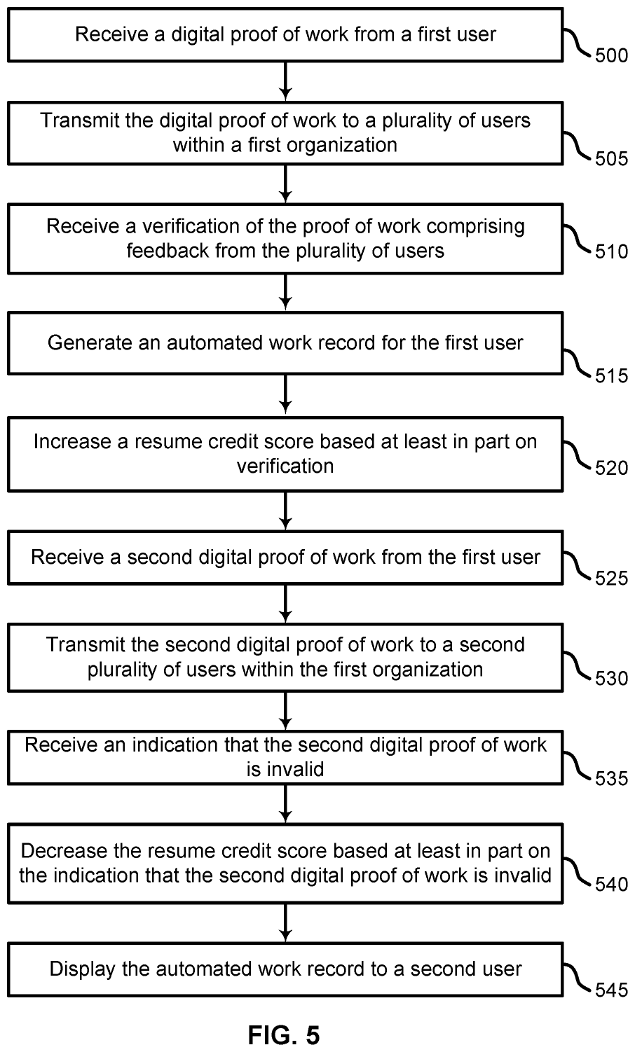

FIG. 5 shows an example of a process for generating a verified work history that is transferable between organizations in accordance with aspects of the present disclosure. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 500, the system may receive a digital proof of work from a first user. In some cases, the operations of this step may refer to, or be performed by, a verification component as described with reference to FIG. 2.

At step 505, the system may transmit the digital proof of work to a plurality of users within a first organization. In some cases, the operations of this step may refer to, or be performed by, a verification component as described with reference to FIG. 2.

At step 510, the system may receive a verification of the proof of work comprising feedback from the plurality of users. In some cases, the operations of this step may refer to, or be performed by, a verification component as described with reference to FIG. 2.

At step 515, the system may generate an automated work record for the first user based at least in part on the verification of the proof of work, wherein at least a portion of the automated work record is associated with the first organization. In some cases, the operations of this step may refer to, or be performed by, a resume component as described with reference to FIG. 2.

At step 520, the system may increase a resume credit score based at least in part on verification, wherein the automated work record comprises the resume credit score. In some cases, the operations of this step may refer to, or be performed by, a scoring component as described with reference to FIG. 2.

At step 525, the system may receive a second digital proof of work from the first user. In some cases, the operations of this step may refer to, or be performed by, a proof component as described with reference to .

At step 530, the system may transmit the second digital proof of work to a second plurality of users within the first organization. In some cases, the operations of this step may refer to, or be performed by, a verification component as described with reference to FIG. 2.

At step 535, the system may receive an indication that the second digital proof of work is invalid. In some cases, the operations of this step may refer to, or be performed by, a verification component as described with reference to FIG. 2.

At step 540, the system may decrease the resume credit score based at least in part on the indication that the second digital proof of work is invalid. In some cases, the operations of this step may refer to, or be performed by, a scoring component as described with reference to FIG. 2.

At step 545, the system may display the automated work record to a second user. In some cases, the operations of this step may refer to, or be performed by, a sharing component as described with reference to FIG. 2.

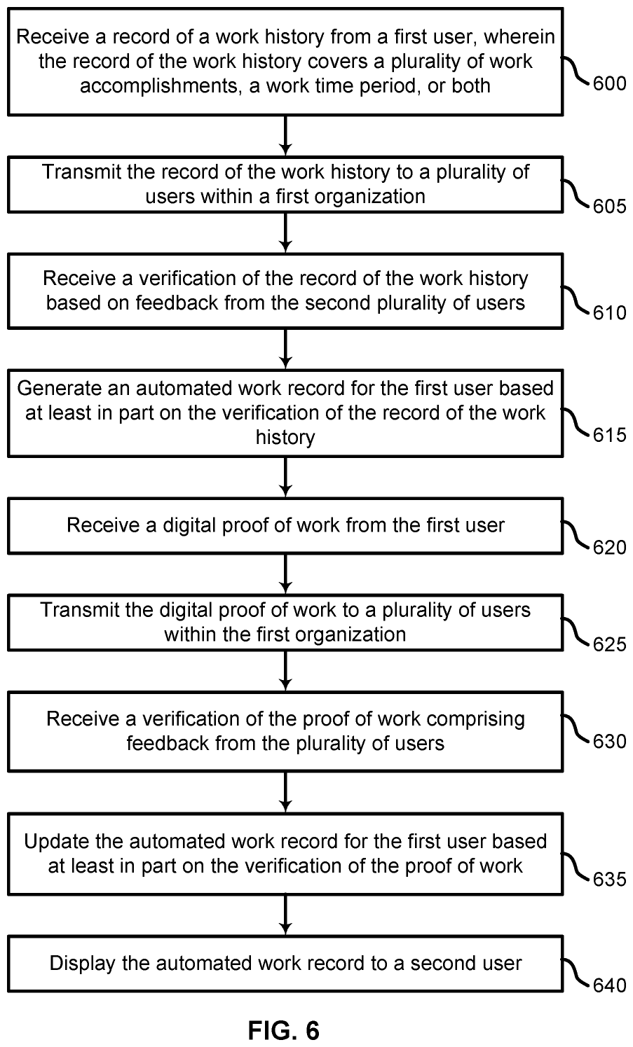

FIG. 6 shows an example of a process for generating a verified work history that is transferable between organizations in accordance with aspects of the present disclosure. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 600, the system may receive a record of a work history from a first user, wherein the record of the work history covers a plurality of work accomplishments, a work time period, or both. In some cases, the operations of this step may refer to, or be performed by, a verification component as described with reference to FIG. 2. That is, in some cases, such as when a user first creates a profile on an application of the system, the user may be able to upload a bulk work history that includes multiple accomplishments. In some cases, bulk uploads may be distinguished from single item uploads because the verification process may not be as reliable for bulk uploads.

At step 605, the system may transmit the record of the work history to a user or a plurality of users within a first organization. However, in some cases, the peer-to-peer validation method may be used only for individual achievements, and a different validation method may be used for bulk uploads (e.g., based on verification from an organizational superior, etc.). In some cases, the operations of this step may refer to, or be performed by, a verification component as described with reference to FIG. 2.

At step 610, the system may receive a verification of the record of the work history based on feedback from the user or plurality of users. In some cases, the operations of this step may refer to, or be performed by, a verification component as described with reference to FIG. 2.

At step 615, the system may generate an automated work record for the first user based at least in part on the verification of the record of the work history. In some cases, the operations of this step may refer to, or be performed by, a resume component as described with reference to FIG. 2.

At step 620, the system may receive a digital proof of work from the first user. In some cases, the operations of this step may refer to, or be performed by, a verification component as described with reference to FIG. 2.

At step 625, the system may transmit the digital proof of work to a second plurality of users within the first organization. In some cases, the operations of this step may refer to, or be performed by, a verification component as described with reference to FIG. 2.

At step 630, the system may receive a verification of the proof of work comprising feedback from the second plurality of users. In some cases, the operations of this step may refer to, or be performed by, a verification component as described with reference to FIG. 2.

At step 635, the system may update the automated work record for the first user based at least in part on the verification of the proof of work, wherein at least a portion of the automated work record is associated with the first organization. In some cases, the operations of this step may refer to, or be performed by, a resume component as described with reference to FIG. 2.

At step 640, the system may display the automated work record to a second user. In some cases, the operations of this step may refer to, or be performed by, a sharing component as described with reference to FIG. 2.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ.

Also the phrase “based on” is not used to represent a closed set of conditions. For example, a step that is described as “based on condition A” may be based on both condition A and condition B. In other words, the phrase “based on” shall be construed to mean “based at least in part on.”

What is claimed is:

1. A method for generating a verified work history, comprising:
receiving a digital proof of work from a first user;
transmitting the digital proof of work to a plurality of users within a first organization;
receiving a verification of the proof of work comprising feedback from the plurality of users;
generating an automated work record for the first user based at least in part on the verification of the proof of work, wherein at least a portion of the automated work record is associated with the first organization; and
transmitting the automated work record to a second user.

2. The method of claim 1, further comprising:
increasing a resume credit score based at least in part on verification, wherein the automated work record comprises the resume credit score.

3. The method of claim 2, further comprising:
receiving a second digital proof of work from the first user;
transmitting the second digital proof of work to a second plurality of users within the first organization;
receiving an indication that the second digital proof of work is invalid; and
decreasing the resume credit score based at least in part on the indication that the second digital proof of work is invalid.

4. The method of claim 1, further comprising:
receiving a record of a work history, wherein the record of the work history covers a plurality of work accomplishments, a work time period, or both;
transmitting the record of the work history to a second plurality of users within the first organization;
receiving a verification of the record of the work history based on feedback from the second plurality of users; and
updating the automated work record for the first user based at least in part on the verification of the record of the work history.

5. The method of claim 1, wherein:
the digital proof of work comprises a digital image of a work product.

6. The method of claim 1, further comprising:
preventing the first user from modifying a verified portion of the automated work record.

7. The method of claim 1, further comprising:
receiving a request from the second user to view the automated work record; and
verifying identifying information of the second user, wherein the identifying information of the second user comprises an association with a second organization different from the first organization, wherein the automated work record is displayed based at least in part on the verification of the identifying information.

8. The method of claim 1, further comprising:
receiving a request from the first user to provide access to the automated work record to the second user, wherein the automated work record is displayed based at least in part on the request.

9. The method of claim 1, further comprising:
receiving an indication that the first user has purchased access to the automated work record; and
determining that the first user is authorized to provide access to the automated work record based on the indication, wherein the automated work record is displayed based at least in part on the determination.

10. The method of claim 1, further comprising:
receiving an indication that the second user has purchased access to the automated work record; and
determining that the second user is authorized to provide access to the automated work record based on the indication, wherein the automated work record is displayed based at least in part on the determination.

11. The method of claim 1, further comprising:
receiving a request to create a work category from a representative of the first organization; and
generating the work category based on the request, wherein the digital proof of work corresponds to the work category.

12. The method of claim 1, further comprising:
identifying a subdivision of the first organization comprising the first user, wherein the digital proof of work is transmitted to the plurality of users based at least in part on the subdivision.

13. The method of claim 12, wherein:
the subdivision is associated with a geographic region.

14. The method of claim 1, wherein:
the automated work history comprises work achievements, challenge completions, an engagement rating, a peer comparison, an estimate of monetary value, or any combination thereof.

15. The method of claim 1, further comprising:
transmitting a subsequent digital proof of work for a third user in the first organization to the first user;
receiving feedback on the subsequent digital proof of work from the first user; and
updating the automated work record of the first user based on the feedback from the first user for the subsequent digital proof of work.

16. The method of claim 15, further comprising:
determining whether the feedback received from the first user is consistent with other feedback received for the subsequent digital proof of work, wherein the automated work record of the first user is updated based on whether the feedback received from the first user is consistent.

17. The method of claim 1, further comprising:
querying a database of the first organization for information corresponding to a transaction associated with the digital proof of work; and
receiving an indication from the database indicating whether the digital the transaction is valid, wherein the automated work history is generated based at least in part on the indication.

18. An apparatus for generating a verified work history, comprising: a processor and a memory storing instructions and in electronic communication with the processor, the processor being configured to execute the instructions to:
receive a digital proof of work from a first user;
transmit the digital proof of work to a plurality of users within a first organization;
receive a verification of the proof of work comprising feedback from the plurality of users;
generate an automated work record for the first user based at least in part on the verification of the proof of work, wherein at least a portion of the automated work record is associated with the first organization; and
increase a resume credit score based at least in part on verification, wherein the automated work record comprises the resume credit score.

19. The apparatus of claim 18, the processor being further configured to execute the instructions to:
receive a record of a work history, wherein the record of the work history covers a plurality of work accomplishments, a work time period, or both;
transmit the record of the work history to a second plurality of users within the first organization;
receive a verification of the record of the work history based on feedback from the second plurality of users; and
update the automated work record for the first user based at least in part on the verification of the record of the work history.

20. A non-transitory computer readable medium storing code for generating a verified work history, the code comprising instructions executable by a processor to:
receive a digital proof of work from a first user;
transmit the digital proof of work to a plurality of users within a first organization;
receive a verification of the proof of work comprising feedback from the plurality of users; and
generate an automated work record for the first user based at least in part on the verification of the proof of work, wherein the first user is prevented from modifying a verified portion of the automated work record.
